(19) United States
(12) Patent Application Publication
(10) Pub. No.: US 2008/0059613 A1
(43) Pub. Date: Mar. 6, 2008

(54) System and Method for Enabling Directory-Enabled Networking

(76) Inventor: John Strassner, Colorado Springs, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/929,689

(22) Filed: Oct. 30, 2007

Related U.S. Application Data
(62) Division of application No. 10/213,958, filed on Aug. 7, 2002.

(51) Int. Cl. G06F 15/177

(52) U.S. Cl. 709/220

(57) ABSTRACT

A system and method for managing and performing network configurations is described. In one embodiment, an assembler can look up the customer's account and identify the network devices that are both required for a requested transaction. Using the knowledge data models (KDM) for the identified network devices, the assembler can determine which resources are available. For each relevant resource, the assembler can gather the appropriate configuration schemata from the KDMs. The assembler can then identify the parameters within the network resource's schemata that are configurable, select the correct configuration for those parameters, and build the necessary configuration instructions based upon the business rules defined by the customer. These configuration instructions could then be pushed to the appropriate network devices.

### RELATED APPLICATIONS

The present application is related to commonly owned and assigned application numbers:

U.S. Ser. No. 09/730,864, entitled System and Method for Configuration, Management and Monitoring of Network Resources, filed Dec. 6, 2000;

U.S. Ser. No. 09/730,680, entitled System and Method for Redirecting Data Generated by Network Devices, filed Dec. 6, 2000;

U.S. Ser. No. 09/730,863, entitled Event Manager for Network Operating System, filed Dec. 6, 2000;

U.S. Ser. No. 09/730,671, entitled Dynamic Configuration of Network Devices to Enable Data Transfers, filed Dec. 6, 2000;

U.S. Ser. No. 09/730,682, entitled Network Operating System Data Directory, filed Dec. 6, 2000;

U.S. Ser. No. 09/799,579, entitled Global GUI Interface for Network OS, filed Mar. 6, 2001;

U.S. Ser. No. 09/942,834, entitled System and Method for Generating a Configuration Schema, filed Aug. 29, 2001,

U.S. Ser. No. 09/942,833, entitled System and Method for Modeling a Network Device's Configuration, filed Aug. 29, 2001,

U.S. Ser. No. 10/037,892, entitled System and Method for Evaluating Effectiveness of Network Configuration Management Tools, filed Oct. 23, 2001,

U.S. Ser. No. 09/991,764, entitled System and Method for Generating a Representation of a Configuration Schema, filed Nov. 26, 2001, and

U.S. Ser. No. 10/145,868, entitled System and Method for Transforming Configuration Commands, filed May 15, 2002,

all of which are incorporated herein by reference.

### FIELD OF THE INVENTION

The present invention relates to network device management. In particular, but not by way of limitation, the present invention relates to systems and methods for maintaining network device configurations and/or generating network device configurations.

### BACKGROUND OF THE INVENTION

Network devices such as routers, switches and optical devices are becoming increasingly more complicated. Typical network devices now require thousands of lines of specialized configuration instructions to operate properly. Unlike most software applications, the instructions that operate network devices can be changed on a frequent basis. The nature of network devices often requires that each version of a device's configuration be stored. This can be used to facilitate returning the network back to a known good state in the event of a configuration failure or other network problem. Because changes are so frequent, sizable repositories of old configurations are generated for each device. When these sizable repositories are accumulated across the thousands of network devices that frequently make up a network, cumbersome, inefficient repositories are created. In some cases, these repositories are so large that they are not useful.

Present network architecture generally requires that configuration instructions and the capabilities of a network device (referred to as “configuration knowledge”) be stored together as an atomic unit. This single-data-model approach has proven to be difficult to maintain in sophisticated networks. When network administrators, for example, archive only the configuration instructions, the configuration knowledge that was used to generate those configuration instructions is lost, and when the network administrators attempt to archive both the configuration instructions and the configuration knowledge, the size of the archived file becomes too large because the knowledge used to generate the configuration is many times the size of the actual configuration. Moreover, for a given version of the device, the device knowledge is invariant, e.g., the operating system and hardware for the network device are the same. Thus, repeatedly archiving the configuration knowledge is wasteful. Finally, there are usually far too many versions of a particular network device's operating system to enable efficient storage, search and retrieval of the configuration knowledge used to generate a given device data configuration. Accordingly, a system and method are needed for more efficiently storing configuration knowledge and configuration instructions.

Network administrators have also found that the single-data-model implementation makes reverting to previous configurations difficult. When the configuration data and the configuration knowledge are bundled together as an atomic unit, network administrators have significant difficulty in reverting to a previous device configuration when both the configuration instructions and the configuration knowledge change. For example, when a network device is upgraded to run a new version of its operating system, both the configuration knowledge and the configuration instructions are changed. If the upgrade fails, rolling back the changes to a known state could be difficult. Accordingly, a system and method are needed to address the issues with reverting to previous configurations.

Present network technology suffers from yet another drawback in that it lacks a common information model that can be used to derive each of the application-specific configurations. One advantage of a common information model is that it can be used to model device capabilities independent of vendor implementations. This lack of an adequate common information model results in network applications having difficulty in retrieving and sharing network information from different network devices. Even more problematic is the fact that the lack of the common information model results in different network applications being unable to share different network data about the same network device for different applications. For example, each application might implement its own procedure for discovery of network devices because it cannot understand information generated by another network application. Accordingly, a system and method are needed to provide a common information model that can be used to derive each of the application-specific data models.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment of the present invention, the configuration of a network device is separated into two portions: configuration knowledge and configuration instructions. The configuration knowledge abstractly represents the capabilities of a network device or resource. For example, the configuration knowledge for a router might indicate the types of traffic conditioning, chip organization, and routing protocols that are available to that router. It is important to note that configuration knowledge is not necessarily limited to one particular type of knowledge. Knowledge, for example, can broadly be classified into physical and logical knowledge. Configuration knowledge can be comprised of individual configuration schemata, which define the individual portions that make up the complete configuration knowledge. The configuration knowledge for a particular network device also is referred to as a knowledge data model (KDM).

Because the KDM for a device is constructed from a set of individual schemata, when the capabilities of that network device are changed, the corresponding schemata can be changed without otherwise rebuilding the entire KDM. For example, if a new card is added to a router, then the schemata for that new card is added to the KDM of the router. The remaining portion of the KDM, however, may remain unchanged. Similarly, if a router is updated with a new operating system (OS) the relevant schemata in the KDM can be modified. Notably, the individual features of the device can be modeled in individual schemata so that the schemata and features can be changed independently.

The configuration instructions for a particular network device are derived from the KDM for that device. Moreover, each configuration instruction set can be associated with a particular version of the KDM. For example, if a router is updated with a new operating system (OS), a new version of the KDM that reflects the new OS is created. Subsequent sets of configuration instructions can be associated with the new version of the KDM. Thus, any set of configuration instructions can be identified as being associated with a certain network device configuration. In one exemplary embodiment of the KDM, a version of knowledge can be directly linked to the combination of {vendor, device type, device family, device model, OS version}. This set of parameters can specify a given KDM.

In one exemplary embodiment, the present invention can include an assembler connected to a storage device that contains groups of configuration schemata. These groups of schemata represent the resources involved in meeting certain customer requirements and requests. For example, the schemata could be grouped according to performance, reliability, security, etc. In essence, these groups of schemata can represent a mapping between business needs and network resources. This mapping, in one embodiment, enables business rules to drive network configuration.

Another embodiment of the present invention enables customers to use business logic to request network services. For example, when a customer requests some action regarding the network, the assembler can look up the customer's account and identify the network resources that are both required for the transaction and available to the customer. The customer, for example, might have access to routers A, B, and C, all of which are necessary for turning-up service between two points. Using the KDM for each of the routers, the assembler can determine what resources, e.g., routing protocols or cards, are required of the routers to provision the requested customer service. For each relevant resource, the assembler can gather the appropriate configuration schemata or generate modifications from the KDMS. For example, the assembler could gather the relevant configuration schemata for a particular model of network card included in router A.

The abstraction provided by the KDM can make it easier to compare device capabilities as compared to comparing configuration commands. For example, each device can have different commands, making the comparison exceedingly difficult. Further, each vendor's configuration commands are not at the same abstraction level and do not use the same terms. The assembler can then identify the parameters within the network card's schemata that are configurable, select the correct configuration for those parameters, and build the necessary configuration instructions based upon the business rules defined by the customer. These configuration instructions could then be pushed to the appropriate network devices.

In another embodiment, the assembler responds to a customer's service request by identifying the necessary resources to meet the request and by retrieving a group of schemata that indicates the individual schemata relevant to the request. For example, the assembler could access the Voice QoS grouping that identifies a set of schemata that impact QoS for voice transmissions. The assembler could then match the relevant schemata from the group to the necessary resources, e.g., router or card, and build the necessary configuration instructions. These configuration instructions could then be pushed to the appropriate network devices.

In another embodiment of the present invention, the assembler can generate separate KDM and configuration instruction set archives. In other words, the KDM for a network device (or network resource) can be stored separately from the actual configuration instructions. Each set of configuration instructions, however, may be associated with the KDM that was used to build it. Thus, multiple sets of configuration instructions could be associated with a single KDM. Additionally, a difficult task can be migrating configurations from one version to another version of the device OS. The KDM provides the facility to compare different versions of the same device OS and enable one to be migrated to another version.

In yet another embodiment of the present invention, network management applications are configured to retrieve data from the various KDMs. Because the KDMs are abstractions of the actual device configurations, the network management applications can interact with the KDMs in a standardized fashion without necessarily understanding the exact syntax required by each network device. For example, Cisco™ routers utilize a CLI (command line interface) with a proprietary syntax that can change with every new release of the OS. Network applications must be able to understand Cisco's proprietary syntax and must update their systems with every change in that syntax. One embodiment of the present invention alleviates some of this difficulty by abstracting the capabilities of network devices in a KDM rather than lumping the capabilities with the actual configuration instructions. In essence, the separation of the configuration knowledge and the configuration instructions allows for better sharing of data between network applications.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of one embodiment of the present invention;

FIG. 2 illustrates versioned KDMs and configuration instructions;

FIG. 3 illustrates one organization of a KDM for a network device;

FIG. 4 is a block diagram of a network including network management applications and a centralized KDM storage device and configuration data storage device;

FIG. 5 is a flowchart of one method for implementing a roll-back using KDMs and versioned configuration instructions; and

FIG. 6 is a flowchart of one method for implementing a business policy in a network.

### DETAILED DESCRIPTION

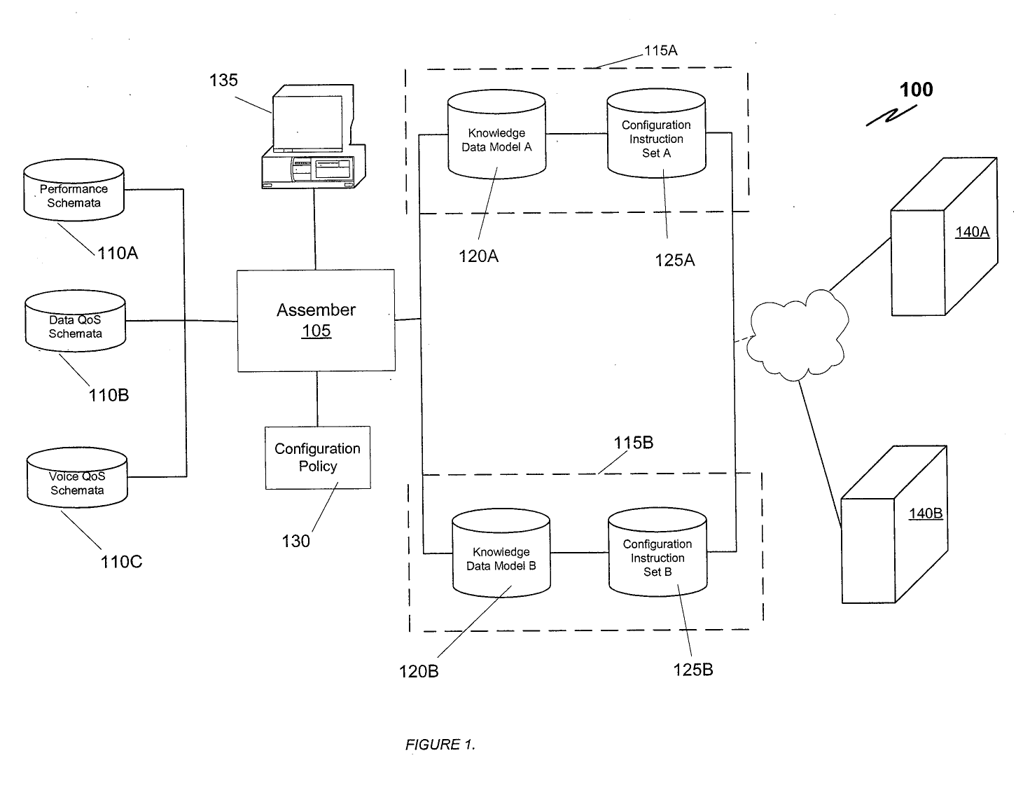

Referring now to the drawings, where like or similar elements are designated with identical reference numerals throughout the several views, and referring in particular to FIG. 1, it is a block diagram 100 of one embodiment of the present invention. In this embodiment, an assembler 105 is connected to a configuration schemata storage device 110, device configuration storage devices 115--including KDMs 120 and configuration instruction sets 125—a configuration policy device 130, and a client 135. Each of the network devices is associated with a KDM 120 and one or more configuration instruction sets 125. For example, router 140A, which is connected to network 140, is associated with KDM A 120A and configuration instruction set A 125A.

The device configuration for each network device is separated into two portions: configuration knowledge (referred to as the KDM) and configuration instruction sets. The KDM abstractly represents the capabilities of a network device or resource. For example, the KDM for a router might indicate the available types of traffic conditioning, chip organization, and routing protocols. The configuration instruction sets represent the instructions used to configure a network device. A given device may have multiple instruction sets associated with it. Also, a given instruction set is likely to use only a small portion of the KDM, because typically individual devices only use a small set of possible features.

KDMs are comprised of a number of individual configuration schemata that describe functions and capabilities of network resources. Individual schemata can even be grouped to address particular network functions such as performance, QoS for data, QoS for voice, etc. Typical configuration schemata can describe:
How to treat various types of traffic, such as
   Whether to deny, forward, or queue traffic.
   How to condition traffic. (e.g., rate limit a flow or drop a packet).
Routed and routing protocol configuration.
Define the physical configuration and composition of a device.
General communication definition-unicast, broadcast, multicast, any cast.
Security configuration, including
   Securing communications via, for example, IPSEC.
   Determining who can log into the device to look at or change its configuration.
Service configuration, such as how virtual private networks are formed and maintained.

The combination of schemata to represent a network device or resource is referred to as the KDM. The KDMs for the various network devices can be stored together in a central storage device or distributed across multiple storage devices. Similarly, the configuration instruction sets for the various network devices can be stored together in a central storage device or distributed across multiple storage device. Additionally, the configuration instruction sets can also be stored at the individual network devices.

The KDM can be stored in a variety of formats, including XML. In one embodiment, the KDM is stored in a directory as a set of directory entries and LDAP or DAP is used as the access protocol. Such an implementation can use different types of relationships to associate different information with the device. Each type of relationship can be defined by the KDM.

Generally, a directory defines an object class as a set of entries that share the same characteristics. For example, an object class could be a router or a Cisco router. A typical directory has three types of object classes: abstract, structural, and auxiliary. Abstract classes are used as the highest level of abstraction of a class hierarchy to represent specific types of information. For example, physical characteristics and logical characteristics of a network device represent two distinct types of information that could be used as abstract classes of a KDM. Thus, a directory might define a root and two abstract classes: physical characteristics and logical characteristics. By making a class abstract, it generally cannot be instantiated.

Structural object classes, however, are instantiable and are used to define the contents of the DIT. An example of a structural class could include a particular device's configuration. Auxiliary object classes can be used to add to or remove from the list of attributes permitted in a particular structural object class or classes. The idea is for an auxiliary class to collect information that can augment other classes. One embodiment of the present invention can use auxiliary object classes to contain common information and attach that information to structural classes that represent differently types of resources.

The configuration instruction sets can also be stored in a variety of formats. In one embodiment, the configuration instructions sets are stored in a proprietary format that corresponds to the network device that uses the configuration instructions. This in turn can be stored as a single entry called a Binary Large Object (“Blob”) in the directory. In other embodiments, the configuration instructions could be stored in an intermediate format, e.g., XML, that is subsequently translated into a proprietary format. In this case, it may be more convenient to store the individual XML objects as separate directory entries. In other cases, the entire XML could be stored as a single entry. The choice can be determined by the application.

Still referring to FIG. 1, the assembler 105 is enabled to receive a service request from a client 135. For example, the user might request that a connection between the New York office and the new San Francisco office be established and that the new link be optimized for Voice data. As another example, a program may request that a particular customer service be changed. In response, the assembler 105 could identify the resources needed to establish the link. For example, the assembler 105 could search an inventory of available network devices and identify those devices that could be used to establish the link. The assembler 105 could then identify the relevant schemata for turning-up service and for voice optimization. In one embodiment of the present invention, the assembler 105 selects a grouping of schemata such as “QoS Voice” 110C that identifies the schemata and possibly the settings associated with voice QoS. The assembler can then link the identified schemata with the identified resources. For example, if an identified resource includes a particular card within a router, the schemata that make up the KDM for that card (or router) can be matched with the schemata that are needed to turn-up service and optimize voice QoS.

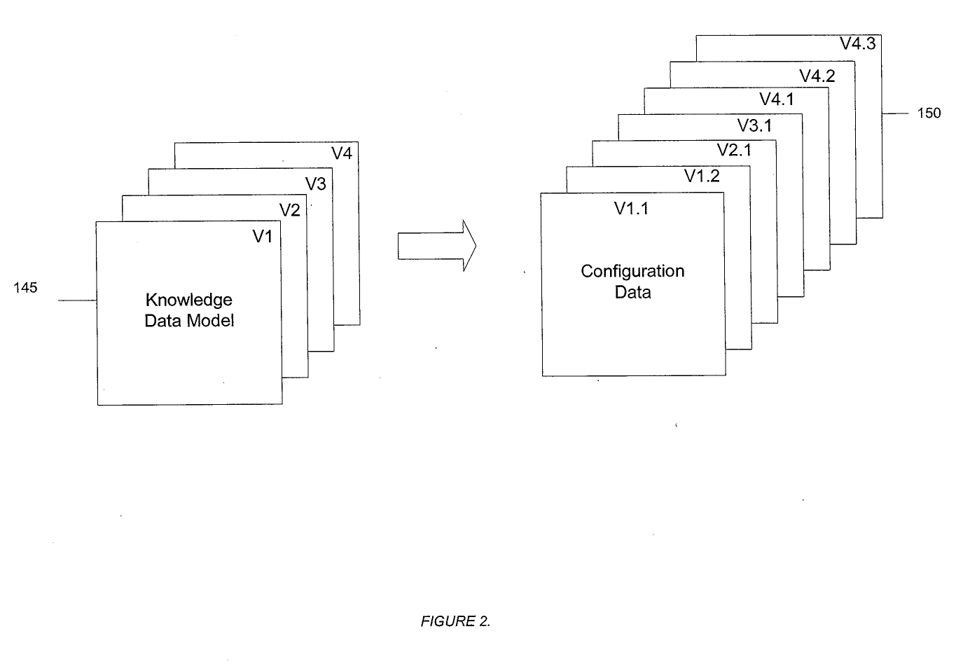

Referring now to FIG. 2, it illustrates versioned KDMs 145 and configuration instruction sets 150 that correspond to a particular network device. In this embodiment, the KDM 145 includes versions 1 through 4, and the configuration instruction sets 150 include versions 1.1 through 4.3. Each version of the configuration instruction sets is associated with at least one KDM 145. For example, configuration instruction sets V1.1 and V1.2 correspond to KDM V1. Similarly, configuration instruction set V2.1 corresponds to KDM V2. Thus, for any set of configuration instructions, the KDM 145 used to build that set of instructions can be determined.

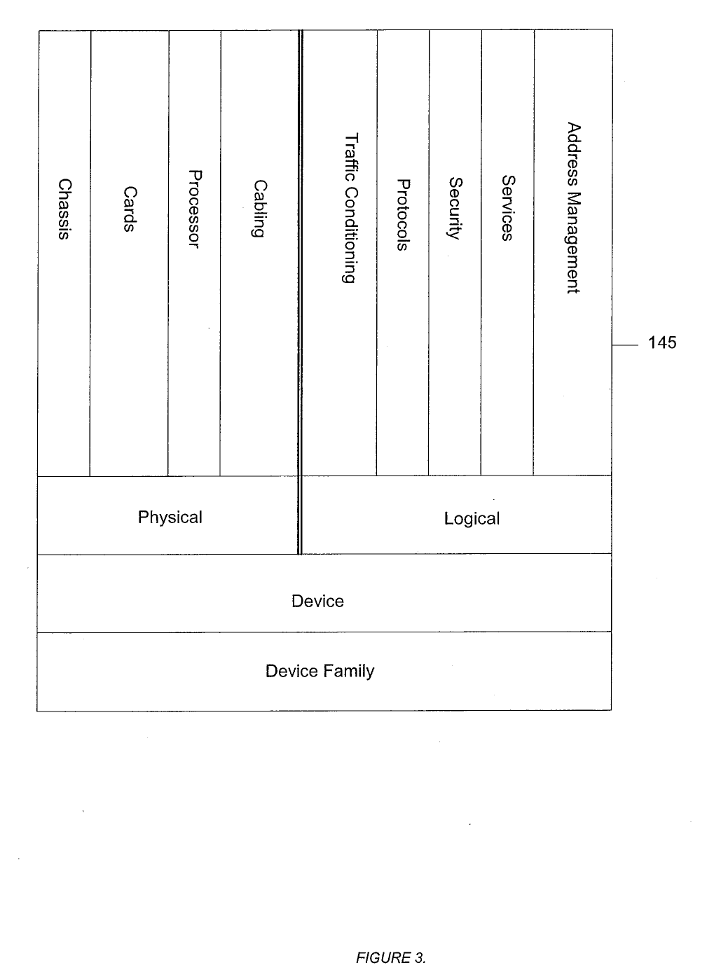

Referring now to FIG. 3, it illustrates one organization of a KDM 145. This abstraction represents a family of devices that all share common features and/or other characteristics. The device family layer is refined by the device abstraction layer, which represents a software abstraction of a specific device. The device family layer is then further refined into its physical and logical aspects, which are represented by the physical and logical abstraction layers. By defining the device according to its physical and logical capabilities, the KDM 145 can support applications that require access to only physical or logical information. For example, the KDM 145 can support a physical inventory application that has no need of logical information. Likewise, the KDM 145 can support a capacity planning application that has need for both physical and logical information.

The physical and logical layers can be refined according to the features of the family of devices being represented. For example, the logical abstraction can include: address management, services, security, protocols, and traffic conditioning. Similarly, the physical abstraction can include: cabling, processors, cards, and chassis. These refinements are not inclusive, but rather exemplary for one type of device. Other abstractions include: users, groups, organizations, resource roles, services, capabilities, constraints, products, policies, processes, applications, etc. Moreover, the KDM 145 can be applied to most network resources, including routers, router components, switches, switch components, fabrics, optical devices, and optical components.

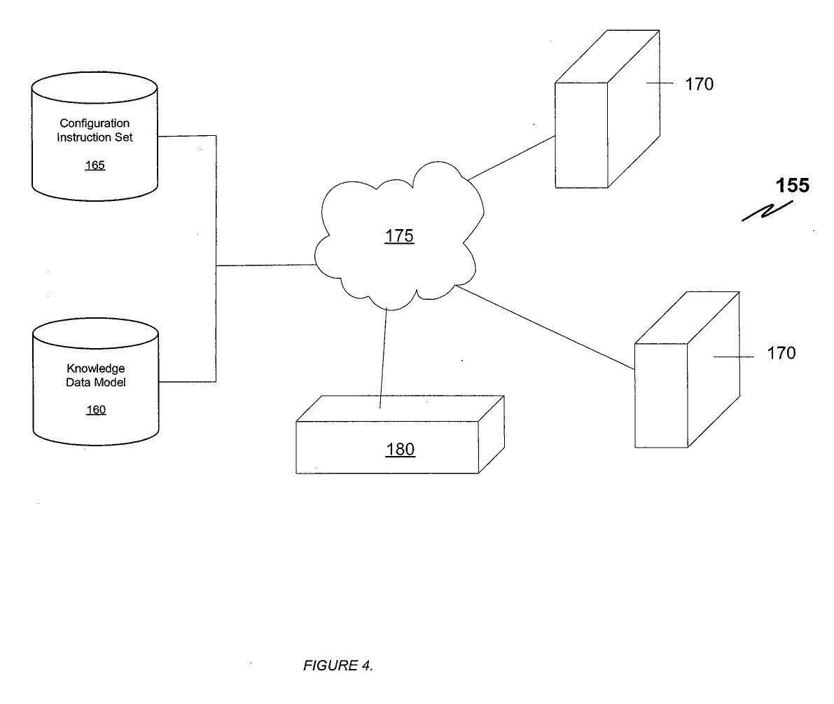

Referring now to FIG. 4, it is a block diagram of a system 155 that includes network management applications connected to a centralized KDM storage device 160 and configuration data storage device 165. In this embodiment, a plurality of network management devices 170, including network management applications, are connected to a KDM storage device 160 and a configuration data storage device 165 through a network 175. The KDM storage device 160 and the configuration data storage device 165 are also connected to network devices such as router 180.

When a network management device 170 needs configuration data about a particular network device or group of network devices, the network management device 170 can access the network device directly and read the relevant information. This process, however, generally requires the network management device 170 to understand the particular syntax of the network device's configuration. In one embodiment of the present invention, however, the network management device 170 can access the KDM storage device 160 and retrieve the relevant KDMs or portions thereof. Because the KDMs are abstractions of the device-specific instructions, the network management devices 170 generally are not required to understand the device-specific syntax of a particular network device. For example, a physical inventory application could access the KDMs for the relevant network devices and determine the cards that are used by each device without regard to the syntax of the actual configuration instructions.

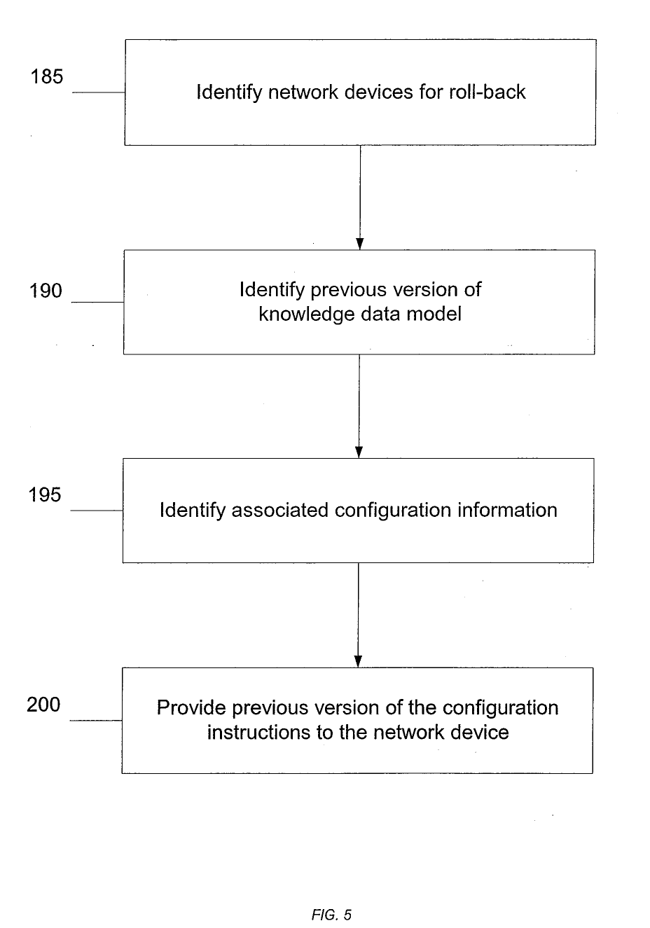

Referring now to FIG. 5, it is a flowchart of one method for implementing a roll-back (e.g., the replacing of a new set of configuration instructions with a previous set of configuration instructions) using KDMs and versioned configuration data. Roll-backs are often useful for network administrators after network attacks or after unsuccessful network device updates-although they are useful in several other cases. For example, new hardware is often added to existing routers in a network. This new hardware can introduce new capabilities to the router that are reflected in a new version of the router's KDM. Additionally, the configuration instruction set for the router is usually modified to engage the new hardware. Thus, in this type of system upgrade, both the KDM and the configuration instruction set for the router are modified.

Assuming that a system upgrade is unsuccessful for some reason, network administrators often wish to roll-back the configuration to a previous, known configuration. For example, if the added card was defective, the network administrator might want to remove the defective card and roll-back the configuration to a previous configuration that does not use instructions for that card. To roll-back the configuration, the assembler or some other device can identify the device and a version of the KDM that does not reflect the card's presence. Step 185 and Step 190. The configuration instruction sets associated with that KDM can then be identified, and one of those configuration instruction sets can be selected. Step 195. That configuration instruction set can then be pushed to the network device. Step 200.

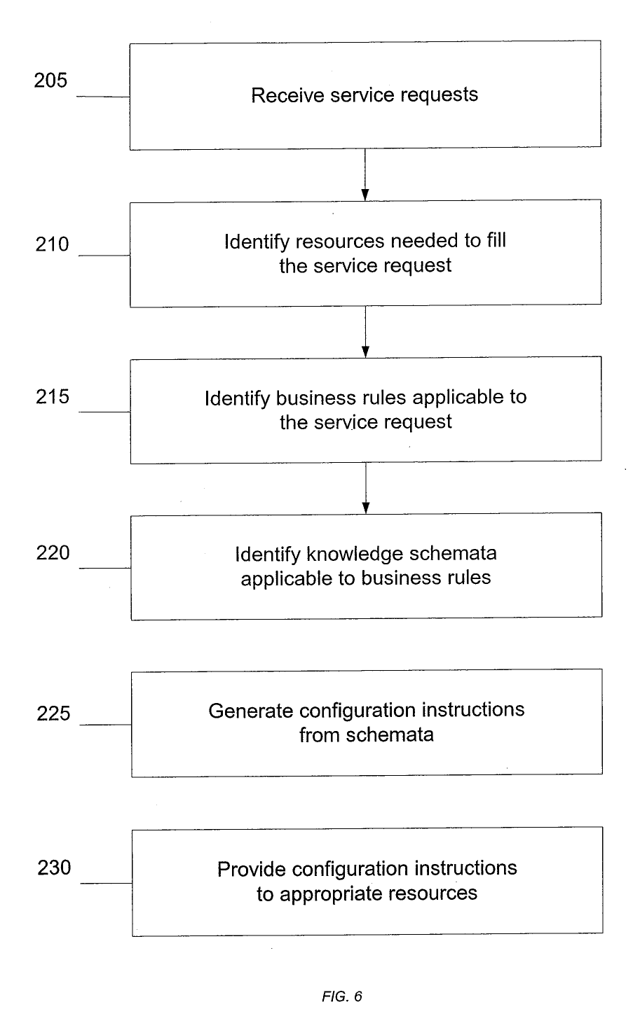

Referring now to FIG. 6, it is a flowchart of one method for implementing a business policy in a network. In this embodiment, a user transmits a service request to the assembler. Step 205. The assembler identifies the network resources and business rules applicable to filling the service request by, for example, retrieving information about the user from the configuration policy database. Steps 210 and 215. The assembler then identifies the individual knowledge schemata or groups of schemata applicable to the service request. Step 220. The assembler can then use those identified schemata to derive the device configuration instructions and push those instructions to the network device. Steps 225 and 230. In one embodiment, the device configuration is derived by binding the variable information of each relevant schemata to the business purpose of the customer. For example, a QoS business purpose could be bound to the various traffic conditioning settings.

Other embodiments of the present invention include comparing and/or contrasting the features of different devices. For example, a network administrator may need to identify devices with similar capabilities and/or configurations. If these devices have different instruction formats, a straightforward comparison of configuration instructions can be extremely difficult. By using the knowledge data model associated with each of the devices, however, the devices can be easily compared without reference to the device's actual configuration instructions and without knowledge about the device's instruction formats. This type of comparison using the knowledge data model allows administrators to automatically or semi-automatically upgrade device operating systems and/or exchange device types. Additionally, this comparison feature allows the features of different devices to be identified and mapped to a particular service provided to a customer.

In conclusion, the present invention provides, among other things, a system and method for managing and utilizing network device configurations. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. Moreover, the term “computer program product” as used in the claims refers to computerized instructions embodied in any form and contained on any medium, including, but not limited to, RAM, magnetic storage, optical storage, carrier wave, etc. Additionally, the term “computer program product” encompasses a computer system operable according to the computer program product or that accesses the computer program product.

1-20. (canceled)

21. A method for configuring a network resource that is part of a network, the method comprising:
receiving a service request from a user;
identifying a network resource that is available to fulfill the service request;
identifying at least one schemata that corresponds to the service request, the schemata representing a capability of the network resource that can be used to respond to the service request;
generating a configuration instruction, using the at least one schemata, for the network resource; and
providing the generated configuration instruction to the network resource to thereby respond to the service request.

22. The method of claim 21, wherein the service request is a quality of service request, and wherein the identified schemata represents a quality of service capability.

23. The method of claim 22, wherein the schemata defines the quality of service capability of the network resource.

24. The method of claim 22, wherein the schemata defines the quality of service capability of a plurality of network resources, and wherein the plurality of network resources including the identified network resource.

25. The method of claim 21, wherein identifying the network resource comprises identifying a network device.

26. The method of claim 21, wherein identifying the network resource comprises identifying a component within a network device.

27. The method of claim 21, wherein the network resource is identified using the schemata.
